(19) United States
(12) Patent Application Publication
(10) Pub. No.: US 2012/0270727 A1
(43) Pub. Date: Oct. 25, 2012

(54) CATALYST

(75) Inventor: Shin YABUUCHI, Musashino (JP)

(73) Assignee: HITACHI, LTD., Tokyo (JP)

(21) Appl. No.: 13/447,618

(22) Filed: Apr. 16, 2012

(30) Foreign Application Priority Data
Apr. 19, 2011 (JP) 2011-092628

(51) Int. Cl. B01J 21/06; B01J 23/26; B01J 23/28; B01J 23/30; B01J 23/34; B01J 23/20; B01J 23/75; B01J 23/755; B01J 23/72; B01J 23/50; B01J 23/22; C01B 33/06; B01J 23/745

(52) U.S. Cl. 502/232; 423/344; 502/350; 502/349; 502/319; 502/321; 502/305; 502/324; 502/338; 502/325; 502/337; 502/345; 502/347; 502/353

(57) ABSTRACT

Provided a compound catalyst allowing for substitution of a rare noble metal such as platinum, palladium and the like or reduction of costs associated with the use thereof. According to the present invention, the oxidation-reduction characteristics thereof may be controlled and catalytic effects similar to those of a noble metal or a transition metal complex may be exhibited by controlling the valence electron concentration of a compound to change the electronic occupation number of the d-band and maintaining the electronic state at the Fermi level of the electronic state identical to a noble metal or a transition metal complex.

### CLAIM OF PRIORITY

The present application claims priority from Japanese patent application JP 2011-092628 filed on Apr. 19, 2011, the content of which is hereby incorporated by reference into this application.

### BACKGROUND OF THE INVENTION

1. Field of the Invention

The present invention relates to a noble metal catalyst, an oxide catalyst, a transition metal complex catalyst, and a product of reactions carried out under the influence of them.

2. Description of the Related Arts

Platinum group elements typified by platinum and palladium have catalyst actions and are available for various uses, and thus many research and development have been conducted. Currently, platinum as a catalyst is usually used for purifying automobile exhaust gases. Since exhaust gases contain harmful gases, NOx in exhaust gases is oxidized in oxidizing atmosphere by using a platinum catalyst, reacts with reducing gases (CO and the like) on the catalyst in reducing atmosphere, and then is reduced into nitrogen. In this way, harmful NOx, CO, and the like are purified by performing oxidation and reduction using the platinum catalyst.

Further, recently, a fuel cell using hydrogen is attracting attention as an energy source which does not depend on the reduction of CO₂ emission or on petroleum. As an electrode catalyst of a fuel cell which does not generate exhaust gases, a platinum- or a platinum-alloy-based catalyst is used and a catalyst in which a noble metal including platinum supported on carbon is used.

However, currently, many platinum group materials are used in a fuel cell for an automobile, and the use of platinum alone significantly increases the costs of the fuel cell. In addition, platinum group elements are scarce in terms of resources. Thus, when demand on them increases, there is also concern about their depletion, and drastic reduction in the amount of their use or development of platinum-substituting catalysts is presently required.

Accordingly, a technology for reducing or substituting an expensive noble metal catalyst used for various uses such as exhaust gas catalysts, fuel cell electrode catalysts, and the like, is needed.

As a method for reducing the amount used of a noble metal catalyst such as platinum, a method for modifying the catalytic activity through compounding with other elements and reducing the amount of their use is proposed. For example, PtBi, PtPb, PtIn, and the like exhibit excellent catalytic performances, which is better than those of platinum is disclosed in J. Am. Chem. Soc., 126, 4043 (2004).

Further, as an attempt to reduce the amount of platinum used, a method for preparing nanoparticles which have a core-shell structure is disclosed in Chemical Science, 2, 531 (2011).

Meanwhile, in Japanese Patent Application Laid-Open Publication No. 2009-043618, it is known that metal oxides, acid nitrogen oxides, perovskite type oxides, pyrochlore structure oxides, or metals or inorganic compounds on which research and development of Chalcogen element compounds is performed act not only as a platinum substituting material, but also as an oxidation-reduction catalyst using an organic metal complex. Recently, the development of an oxygen reduction catalyst in which a transition metal complex such as phthalocyanine, porphyrin, and the like is supported on graphite is in progress Japanese Patent Application Laid-Open Publication No. 2005-230648.

### SUMMARY OF THE INVENTION

However, in the alloying method such as, for example, J. Am. Chem. Soc., 126, 4043 (2004), it is expected that it will be difficult to dramatically reduce the amount of Pt used.

Further, in a method for preparing nanoparticles having a core-shell structure in Chemical Science, 2, 531 (2011), it is possible to reduce the amount used by forming a platinum layer only on the surface of nanoparticles because the surface area thereof is equal to the area of general nanoparticles and platinum is present only on the surface.

However, platinum is present only on the surface, and thus, the problem associated with dissolution of platinum in the solution is apparent that it is necessary to improve the durability. In addition, there is concern about the increase in costs due to a complex process of preparing nanoparticles.

Furthermore, although there have been studies on materials substituting platinum as described in Japanese Patent Application Laid-Open Publication Nos. 2009-043618 and 2005-230648, a performance that can substitute a noble metal catalyst such as platinum, and the like can not be completely be reached due to high resistance to various environments such as acid, alkali, and the like and failure to reach the level of exhibiting high catalytic activity identical to or higher than the activity of platinum.

Therefore, as an embodiment of the present invention in order to address the above-described problem, oxidation-reduction characteristics are controlled and catalytic effects similar to those of a noble metal or a transition metal complex are exhibited by controlling the valence electron concentration of a compound to change the electron occupation number of the d-band around Fermi level.

Specifically, the catalyst of the present invention is one including, as a main component, any one structure of a compound which belongs to the Nowotny chimney-ladder phases, a compound having a C40 structure, a compound having a L2₁ structure, a compound of C1_{b}, and β-FeSi₂.

According to the present invention, the electron occupation number of the d-band may be changed, the electronic structure at the Fermi level may be modified, and oxidation-reduction characteristics may be controlled depending on the purpose by adding an element having a different valence electron number due to doping and controlling the valence electron concentration of a compound.

### BRIEF DESCRIPTION OF THE DRAWINGS

FIGS. 1A and 1B are a density of states of Pt and Pd by the first principles calculation;

FIG. 2 is a schematic view of the occupation number of each orbital electron of the Hexammine cobalt (III) ion by the orbitals of a Co ion and an NH₃ ligand;

FIGS. 3A to 3E are a crystal structure of Mn₄Si₇;

FIG. 4 is a density of states of Mn₄Si₇ obtained by the first principles calculation;

FIGS. 5A to 5C are a relationship between the schematic view of the density of states and the Fermi level;

FIGS. 6A to 6D are crystal structures of the L21 structure, B2 structure, A2 structure, and C1b structure, respectively;

FIGS. 7A and 7B are a density of states of the full Heusler alloy Fe₂VA1 and Fe₂TiSi by the first principles calculation; and

FIG. 8 is a Table showing the relationship between number of valence electron and element.

### DETAILED DESCRIPTION OF THE PREFERRED EMBODIMENTS

### First Embodiment

Hereinafter, prior to the detailed description of the preferred embodiments, a theory which is a premise of the present invention will be described.

There are various metal and transition metal complexes having catalytic activity, and the catalytic activity is greatly modified by not only intrinsic effects of an element but also the coordination aspect of a transition metal surrounding element such as a compound and a transition metal complex. Accordingly, the present inventors have focused attention on the electronic structure of a noble metal and a transition metal complex having catalytic activity.

Hereinafter, characteristics of the electronic structure of platinum and palladium will be described.

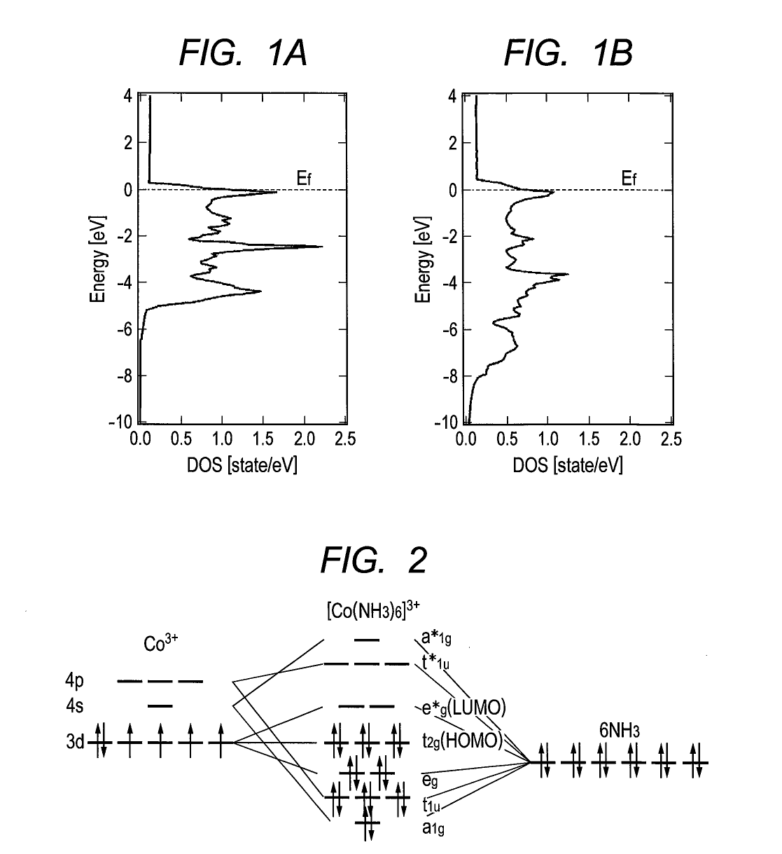

The densities of states of palladium and platinum which are calculated by the first principles calculation are shown in FIGS. 1A and 1B, respectively.

As shown in FIGS. 1A and 1B, palladium, which is a platinum group, is paramagnetic when the element is a single substance. However, magnetic property of palladium is greatly affected by the electronic structure at the Fermi level vicinity because the density of states of palladium at the Fermi level is very high.

It is known that itinerant ferromagnetism is exhibited when palladium is present as nanoparticles. Therefore, a material having great density of states at the Fermi level, such as palladium, satisfies the Stoner criterion for a change in the electronic structure thereof and is a material system that is likely to exhibit ferromagnetism. Further, the magnetic susceptibility of the Pauli paramagnetism is generally expressed as:

χ_{Pauli}=2μ_{B}²D(ε_{F}) (Equation 1)

Here, μ_{B} is Bohr magneton and D(ε_{F}) is the density of states at the Fermi level.

In addition, it is already known that if the rate of the chemical reaction is increased by an increase in density of states at the Fermi level of a platinum catalyst, the catalytic performance is improved, and the degree of catalytic activity is increased by doping platinum with a transition metal such as Molybdenum, and the like.

Actually, the density of states and the paramagnetic susceptibility are closely associated with each other in the relationship of (Equation 1), and it is suggested that the increase and decrease in density of states is strongly correlated with the catalytic activity.

The platinum group has a great density of states due to the contribution of d orbital at the Fermi level, and it can be determined that the catalytic activity may be controlled by increasing and decreasing the density of states at the Fermi level.

Next, characteristics of the electronic structure of a transition metal complex will be described. The electronic structure and oxidation-reduction characteristics of a transition metal complex may be contemplated by using the eighteen electron rule. The eighteen electron rule means that the stability of a transition metal complex is high when the value of (number of d electrons in the transition metal)+(number of electrons donated from ligands) in the transition metal complex is 18.

The number 18 is a number of electrons when the valence orbital of a transition metal element satisfies 5 in the d orbital, 1 in the s orbital, and 3 in the p orbital to have an electronic configuration identical to that of a rare gas. Examples of transition metal complexes satisfying the eighteen electron rule include organic metal complexes such as Hexammine cobalt (III) ion ([Co(NH₃)₆]³⁺), ferrocene (C₁₀H₁₀Fe), and the like.

FIG. 2 illustrates a schematic view of the electronic structure of a Hexammine cobalt (III) ion based on the ligand field theory. The Hexammine cobalt (III) ion has Co as a center and NH₃ coordinated at each apex of a regular octahedron. As shown in FIG. 2, it is known that the number obtained by adding unshared electron pairs from 6 NH₃ ions to 6 as the number of valence electron of Co³⁺ becomes 18, and the highest occupied molecular orbital (HOMO) and the lowest unoccupied molecular orbital (LUMO) reflect the symmetric properties of a molecule and become t_{2g} and e_{g} of the d orbital, respectively. Meanwhile, ferrocene has a structure in which two cyclopentadienyl anions are coordinated on an iron (II) ion at the top and bottom thereof.

The iron atom in the center of ferrocene usually has an oxidation state of +2, and each of two cyclopentadienyl rings has a negative electric charge of −1. A complex satisfying the eighteen electron rule is formed by six d electrons of Fe²⁺ and 6π electrons of two cyclopentadienyl negative ions.

Further, it is known that the ferrocene may control the oxidation-reduction potential by chemically modifying the cyclopentadienyl ring. If an electron-attracting group such as carboxylic acid, and the like is introduced as a chemical modification, the potential shifts to the anodic side. If an electron-donating group such as a methyl group (Me), and the like is introduced, the potential shifts to the cathodic side. For this reason, the decamethyl ferrocene Fe(C₅Me₅)₂ is apt to be oxidized in ferrocene. In addition, oxidation-reduction characteristics of the transition metal complex are greatly changed by not only chemical modification but also effects of element substitution.

The cobaltocene (Co(C₅Me₅)₂), in which the iron of the ferrocene is substituted with a cobalt, has a number of valence electron of 19 and one more valence electron than the ferrocene. The cobaltocene easily reacts with oxygen, unlike the ferrocene which is stable in air.

Furthermore, the decamethyl cobaltocene Co(C₅Me₅)₂, in which the cyclopentadienyl ring of the cobaltocene is chemically modified with a methyl group which is an electron-donating group, has ten methyl groups, and thus is known to be a potent reducing agent.

From the correlation of electronic structure characteristics and oxidation-reduction characteristics of the above-described transition metal complex, it can be determined that the oxidation-reduction characteristics may be modified by addition of an electron-attracting group or an electron-donating group by control or chemical modification of valence electrons based on the eighteen electron rule.

Therefore, the present inventors have considered the electronic structure and oxidation-reduction characteristics of a platinum group and a transition metal complex and controlled the Fermi level of an inorganic compound composed of inexpensive materials by doping, thereby coming up with an idea of a noble metal substituting catalyst comparable to platinum that imitates the electronic structure of a noble metal or a transition metal complex having catalytic activity.

The characteristic which the present inventors have come up with from the viewpoint of imitation of the electronic structure of the transition metal complex is that the complex has the HOMO and LUMO, resulting from the d orbital. The HOMO corresponds to the valence band in an inorganic compound and the LUMO corresponds to the conduction band in an inorganic compound, and thus it is possible to imitate the electronic structure of a transition metal complex by using an inorganic compound having a valence band and a conduction band, due to the d-band. Further, the modification of a transition metal complex from 18 valence electrons corresponds to the modification of the Fermi level by doping, and the like.

The characteristic the present inventors have come up with from the viewpoint of imitating the electronic structure of platinum or palladium is the large density of states at the Fermi level. Materials such as palladium, and the like have a large density of states because the materials are likely to satisfy the condition (Stoner criterion) under which itinerant ferromagnetism is exhibited by a change in ambient environments, resulting from nanoparticulation, and the like.

If the Fermi level of an inorganic compound having a valence band or conduction band composed of the d-band can be modified and an electronic structure having a large density of states such as platinum or palladium can be created, it is possible to imitate the electronic structure of the platinum group to inorganic compounds.

The present invention has been made in an effort to exhibit the catalytic effects similar to those of a noble metal or a transition metal complex by controlling the valence electron concentration of a compound in which the d-band may be controlled to change the occupation number of the d-band and maintaining the electronic structure at the Fermi level of an electronic structure similar to that of a noble metal or a transition metal complex.

According to an embodiment of the present invention, a material for the catalyst includes, as a main component, any one of a compound belonging to Nowotny Chimney-ladder phase which is represented by a composition of TₙXₘ, m and n are within a range that satisfies m/n of about 2 to 1.25, T is a transition metal, and X is a element belonging to the thirteenth group to fifteenth group, a compound having a C40 structure, an L2₁ structure or a C1_{b} structure, and a compound having a transition metal silicide semiconductor, and the Fermi level is controlled in order to obtain a target oxidation-reduction characteristic.

Next, characteristics of a compound belonging to the Nowotny chimney-ladder phase as a main compound of the present invention are described.

The compound belonging to the Nowotny chimney-ladder phase is represented by the composition of TₙXₘ.

Where, m and n are within a range that satisfies m/n of about 2 to 1.25, T consists of an element of the fourth to ninth group, and X consists of an element of the thirteenth to fifteenth group.

Specific materials thereof include TiSi₂, TiGe₂, ZrSn₂, V₁₇Ge₃₁, Cr₁₁Ge₁₉, Mo₉Ge₁₆, Mo₁₃Ge₂₃, Ru₂Sn₃, Ir₃Ga₅, RuGa₂, RuAl₂, Ru₂Ge₃, Ru₂Si₃, Os₂Ge₃, Os₂Si₃, Rh₁₀Ga₁₇, Rh₁₇Ge₂₂, Mn₄Si₇, Re₄Ge₇, Mn₁₁Si₁₉, Mn₁₅Si₂₆, Mn₂₇Si₄₇, Mn₂₆Si₄₅, Mn₇Si₁₂, Mn₁₉Si₃₃, Mn₃₉Si₆₈, Ir₄Ge₅, Co₂Si₃, OsGa₂ and the like.

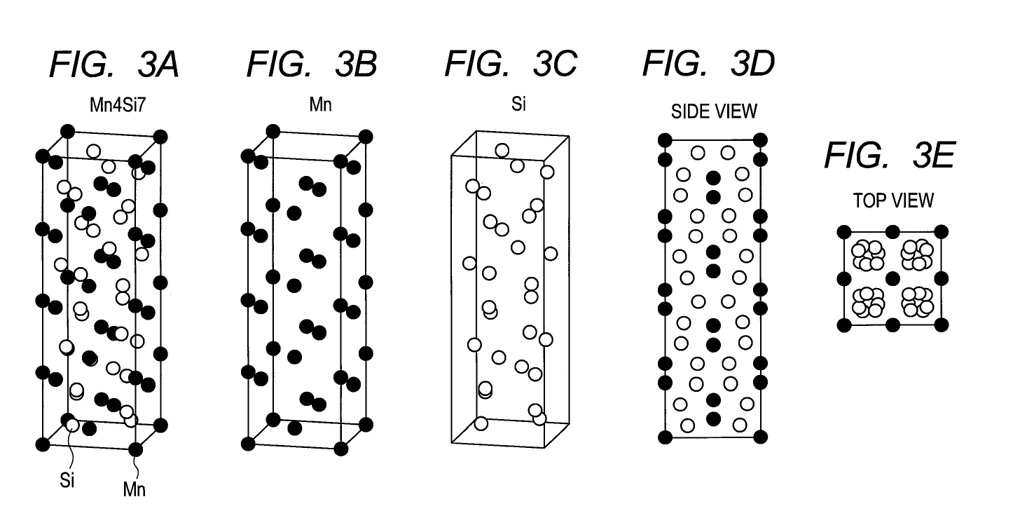

A crystal structure of Mn₄Si₇, which is one of the Nowotny chimney-ladder phase, is shown in FIG. 3A. As shown in FIG. 3A, the crystal structure of Mn₄Si₇ consists of a sublattice (FIG. 3B) of Mn such as a chimney and a sublattice (FIG. 3C) of Si having a spiral ladder-like structure.

In addition, FIGS. 3D and 3E illustrate views of a crystal structure from the side and the top portion.

It is known that most of these Nowotny chimney-ladder phase material systems are appropriate for the fourteen electron rule. The fourteen electron rule is an empirical rule that a transition metal compound behaves like a semiconductor when the valence electron concentration (VEC) per the transition metal is fourteen.

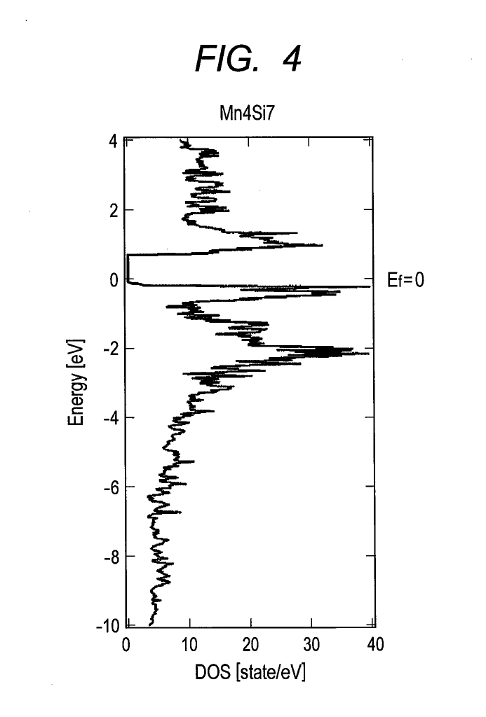

As an example of Mn₄Si₇, the valence electron number eₘₙ in Mn is seven and the valence electron number e_{Si} in Si is four. In the case of Mn₄Si₇, n and m in TₙXₘ are four and seven, respectively. Accordingly, for the valence electron concentration per Mn atom of a transition metal, VEC=e_{Mn}+e_{Si}×(m/n)=14. FIG. 4 illustrates the density of states of Mn₄Si₇. FIG. 4 shows that Mn₄Si₇ has a semiconducting property. Further, FIG. 4 shows that the bottom of the conduction band and the top of the valence electron band have a large density of states. This is due to the 3d orbital of Mn. Accordingly, a material system that includes the valence band and the conduction band having the d-band may be realized by using a material system in the Nowotony chimney-ladder phase.

Next, the control of the Fermi level accompanied by performing doping will be described by using the above-described material system.

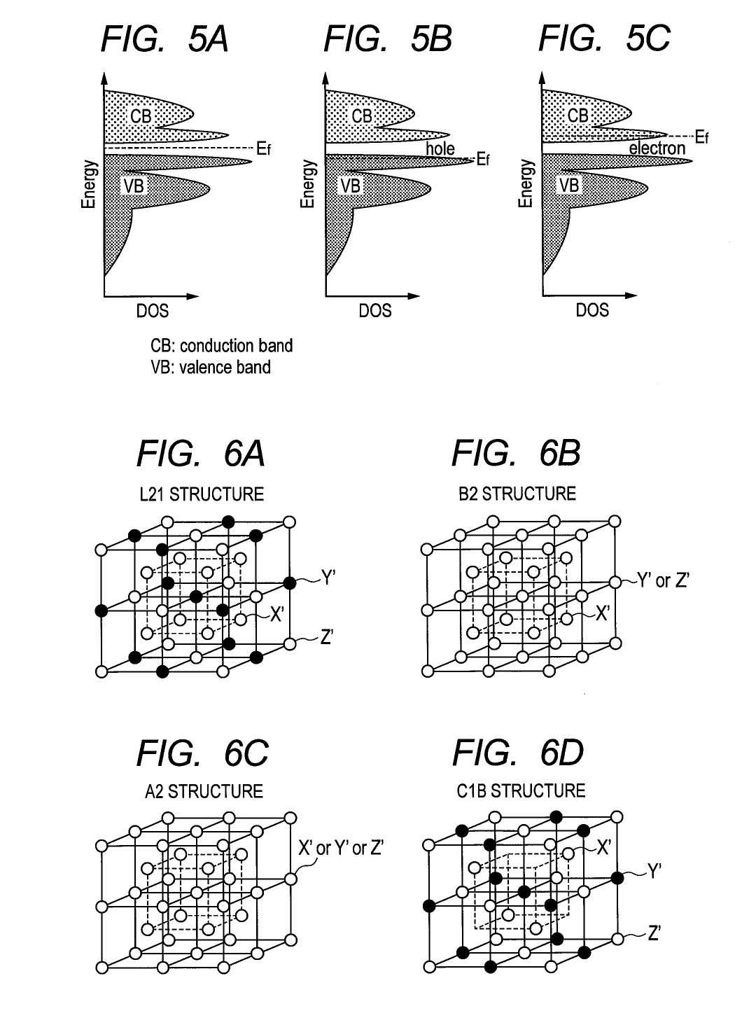

FIG. 5A illustrates a schematic view of the density of states of Mn₄Si₇. If some of Mn in Mn₄Si₇ are substituted with Cr to produce Mn₄₋ₓCrₓSi₇, the VEC=14−x/4 because Cr has a lower valence electron than Mn and the Fermi level lies within the valence band as shown in FIG. 5B. This state is a state in which electrons are easily accepted, as the state in which a lot of holes are present and valence electrons are less than eighteen electrons in view of the eighteen electron rule of a transition metal complex. Further, when the VEC is fourteen or less, the compound is in a hole-doped state, and thus, it is possible to control the compound to a compound having hole conductivity. Meanwhile, if some of Mn in Mn₄Si₇ are substituted with Fe to produce Mn₄₋ₓFeₓSi₇, the VEC=14+x/4 because Fe has a more valence electron than Mn, and the Fermi level lies within the conduction band as shown in FIG. 5C. This state is a state in which electrons are easily supplied, as the state in which a lot of electrons are present and valence electrons are more than eighteen electrons in view of the eighteen electron rule of a transition metal complex.

Further, when the VEC is fourteen or more, the compound is in an electron-doped state, and the carrier may be controlled to be an electron. Accordingly, in the present invention, the oxidation-reduction characteristics may be controlled by increasing and decreasing the VEC based on VEC=14. Although a method for substituting Mn as a transition metal is shown herein, the VEC may be controlled by substituting some of Si with an element having a lower number of valence electron, such as Al, Ga, and the like, or with an element having the same number of valence electron as that of Si, such as Ge, Sn, and the like, or with an element having one more number of valence electron than that of Si, such as P, As, Sb, and the like.

Further, the VEC of Mn₁₁Si₁₉ is about 13.91, and it may be assumed from the VEC value that the compound is in an electronic structure similar to that of a hole-doped semiconductor.

Accordingly, it is also possible to evaluate other compounds having different compositions from the VEC by using a similar crystal structure. In addition, there is a report about the magnetic properties of Mn₄Si₇ and Mn₁₁Si₁₉, showing that Mn₄Si₇ has a possibility of satisfying the Stoner criterion by using doping, and the like. Furthermore, the mechanism of exhibiting the itinerant ferromagnetism shows a strong correlation with the value of VEC.

In the present embodiment, a method for controlling magnetism by modifying the VEC with doping is applied to the control of oxidation-reduction characteristics of a catalyst.

It is possible to control the density of states by using the method, and the control of the catalytic activity of Pt may be realized even in the Nowotny chimney-ladder phase.

A material system in which a platinum group is not used may be realized by using a material system belonging to the Nowotny chimney-ladder phase, such as TiSi₂, TiGe₂, ZrSn₂, V₁₇Ge₃₁, Cr₁₁Ge₁₉, Mo₉Ge₁₆, Mo₁₃Ge₂₃, Mn₄Si₇, Mn₁₁Si₁₉, Mn₁₅Si₂₆, Mn₂₇Si₄₇, Mn₂₆Si₄₅, Co₂Si₃, and the like in the above-described embodiment.

Further, it is also possible to use the Nowotny chimney-ladder phase having an element such as Ru, Rh, and the like. In this case, it is impossible to obtain platinum group-free effects, but effects of reducing the platinum group may be expected.

The VEC of the Nowotny chimney-ladder phase in the above-described embodiment lies within 12 to 15, and thus the VEC may be controlled to a range of 11.5 to 15.5 by substituting the transition metal with a separate transition metal or substituting the thirteenth and fourteenth group elements with a separate representative element. If the VEC exceeds the range, the stability of a crystal structure is lowered and phase separation easily occurs, which is not preferred.

Next, characteristics of a compound of the C40 structural system will be described. Examples of the compounds having a C40 structure include silicide semiconductor CrSi₂. CrSi₂ exhibits a property very similar to that of the Nowotny chimney-ladder phase, and the VEC of CrSi₂ is fourteen, which is a value identical to that of Mn₄Si₇. TaGe₂, VGe₂, HfSn₂, NbGe₂, MoSi₂, TaSi₂, VSi₂, and WSi₂ also have the same C40 structure, and the VEC of these materials is within a range of 13 to 14. Accordingly, it is possible to control the Fermi level based on VEC=14, as in the Nowotny chimney-ladder phase. Further, the 3 phase FeSi₂ becomes a semiconductor while FeSi₂ does not have a VEC value of 14, which is an exception and thus, may be controlled by doping. The β-FeSi₂ has a VEC of 16, which is different from the Nowotny chimney-ladder phase or a C40 structure in VEC that is a basis, and the basis of VEC is sixteen.

Although examples of various silicide catalysts such as V₂Si, VSi₂, Cr₃Si, Cr₂Si, FeSi₂, and the like are known, in the present invention, it is possible to change the density of states by the vicinity phase of a silicide semiconductor in which Si is abundant and the control of the VEC, significantly change oxidation-reduction characteristics of a typical silicide catalyst, and greatly increase the catalytic activity.

A specific compound having an L2₁ structure (full Heusler) is described in the present embodiment. The L2₁ structure (full Heusler alloy) is a structure shown in FIG. 6A, and consists of three elements. Further, Fe₂VA1, Fe₂TiSn, and the like having semimetal and semiconductor-like properties are present in the full Heusler alloy.

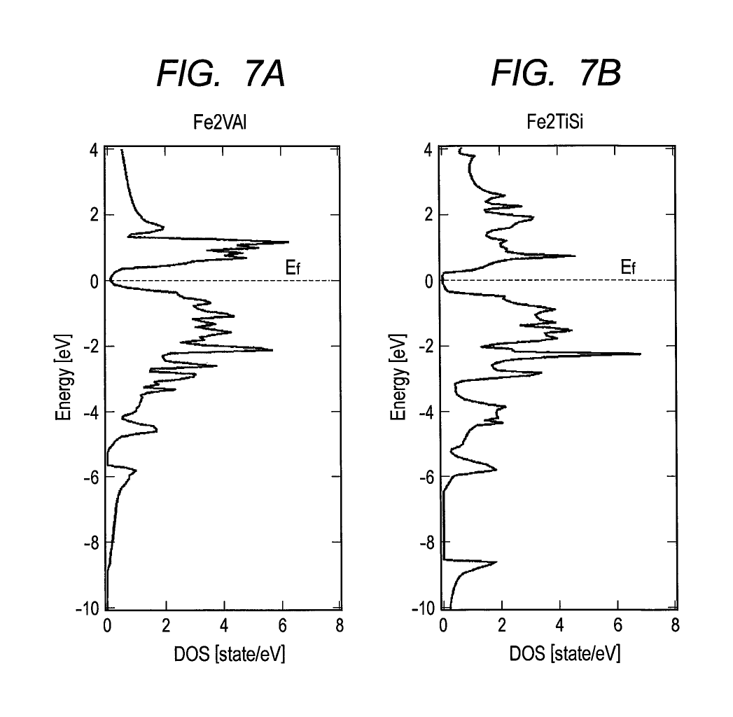

FIGS. 7A and 7B illustrate the density of states of Fe₂VA1 and Fe₂TiSn, respectively. These densities of states have a structure close to a schematic view of the density of states shown in FIG. 5A, and the top of the valence band and the bottom of the conduction band are composed of the d-band.

Further, although these material systems have iron atoms, the magnetic moment thereof disappears or composed of a very low value. This is in the electronic structure different from the magnetic moment of about 2.2μ_{B} in iron having a typical body centered cubic structure, and is in the electronic structure similar to that of Mn₄Si₇ in which the magnetic moment disappears even though Mn is present.

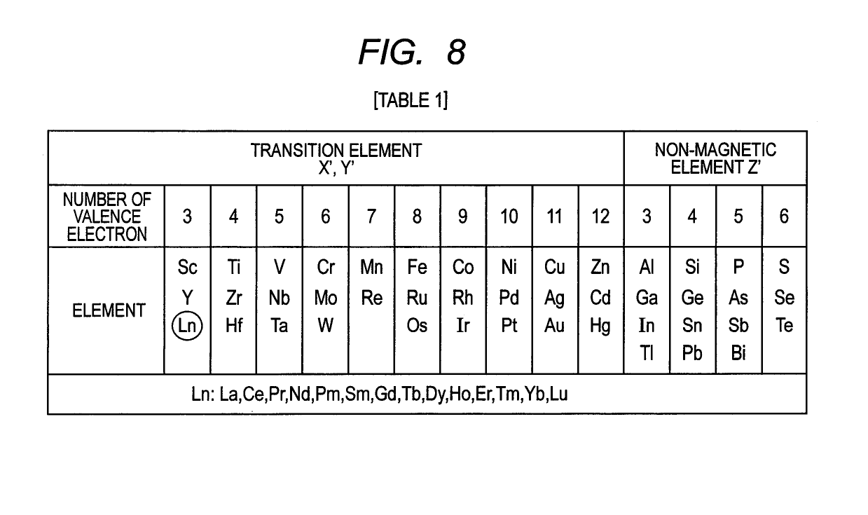

It is known that the full Heusler alloy shows a Slater-Pauling like behavior, and the total number of valence electron per formula unit of Fe₂VA1 is calculated as 8×2+5×1+3×1=24 by using the relationship between the number of valence electron and the element in Table 1 shown in FIG. 8. Further, from the fact that the total number of valence electron in the stoichiometric composition of X′₂Y′Z′ is twenty four, it may be expected that similar properties are all shown.

Accordingly, in the present invention, in the concept of controlling at the Fermi level shown in FIGS. 5A to 5C, it is possible to control at the Fermi level based on that the total number of valence electron is twenty four by using the relationship between the number of valence electron and the element in Table 1 shown in FIG. 8. The doping into the full Heusler alloy in the present invention will be described. If Fe₂VA1 is used as an example, some of the V atoms are substituted with Ti atoms such that the total number of valence electron is changed to some degree. In the case of Fe₂V_{0.8}Ti_{0.2}A1, the total number of valence electron is 23.8 and the Fermi level may be decreased as in FIG. 5B. In the case of Fe₂VAI_{0.8}Si_{0.2}, the total number of valence electron is 24.2 and the Fermi level may be increased as in FIG. 5C. In the above-described Example, a method that Y′ and Z′ in X′₂Y′Z′ are substituted with other elements which are different in number of valence electron is shown. However, X′ may be substituted or a substitution with which a change in the total number of valence electron does not occur may be used.

Mn₂VAI, which is a full Heusler alloy, has a total number of valence electron of 22, and Co₂FeSi has a total number of valence electron of 30. Accordingly, it is possible to control the total number of valence electron of the full Heusler to 22 to 30. However, the chemical stability is shown when the total number of valence electron is in the vicinity of 24, which is in the semiconductor or semimetal electronic, and it is possible to control the carrier type with electronic dope or hole dope. Thus, it is preferable to control the total number of valence electron in a range of 23 to 25. It is preferred that the full Heusler alloy in the present invention has an ordered structure as shown in FIG. 6A. However, a B2 structure as shown in FIG. 6B, in which atomic disorder occurs in the L2₁ structure and the degree of order is deteriorated or an A2 structure as shown in FIG. 6C, in which there is no difference in elements may be included to some degree.

A specific compound having a C1_{b} structure (half-Heusler) in the present invention is described. The half Heusler alloy has a structure as shown in FIG. 6D, and is composed of three elements of X′, Y′, and Z′. Further, NiTiSn, CoTiSb, FeVSb, ZrNiSn, ZrCoSb, and the like having semimetal and semiconductor-like properties are present in the half-Heusler alloy. It may be expected that the half-Heusler alloy shows a Slater-Pauling like behavior as in the full Heusler alloy and that compounds having the total number of valence electron, which is identical to the number of FeVSb, all show similar properties. When the total number of valence electron per formula unit of FeVSb is used as an example, a result of 8×1+5×1+5×1=18 is obtained, and the stoichiometric composition of X′Y′Z′ has a total number of valence electron of 18. In the composition in which the number of valence electron in Table 1 shown in FIG. 8 is in the vicinity of 18, it may be expected that semiconductor or semimetal-like properties, in which the top state of the valence electron band and the bottom state of the conduction band are in the d-band, are shown. Accordingly, in the case of the half-Heusler alloy, the fact that the total number of valence electron is 18 is based on the calculation of the number of valence electron in Table 1 shown in FIG. 8, in the stoichiometric composition of X′Y′Z′. Further, even in the half-Heusler alloy, the total number of valence electron may be changed and the Fermi level may be changed by substituting some elements of X′Y′Z′. In addition, in the half-Heusler alloy, it is preferred that doping is performed such that the total number of valence electron is in a range of 17 to 19 in the vicinity of 18 by substituting each element of X′Y′Z′ with other elements, which are different in the number of valence electron.

When the above-described material is used as a catalyst, a fine particle form or a minute wire form may be used. In order to increase the surface area and widen a region in which the catalytic action is exhibited, it is preferable to take a nano-sized fine particle or nano-wire form. The nano-sized fine particles or nano-wires may be supported on carbon, and the like.

In the present invention, when a catalyst is prepared in order to cause a reduction reaction to take place, it is preferable to allow the VEC of each crystal structure system or the total number of valence electron to have a number more than a basis number of electrons. Further, when a catalyst is prepared in order to cause an oxidation reaction to take place, it is preferable to allow the VEC of each crystal structure system or the total number of valence electron to have a number less than a basis number of electrons.

The crystal structure of a catalyst according to the present invention may be easily confirmed by X-ray diffraction (XRD). Further, even with respect to fine particle samples, the crystal structure of a single crystal or a polycrystal may be confirmed by observation of a lattice image with an electronic microscope such as Transmission Electron Microscope (TEM), and the like or from a spot shape pattern or a ring shape pattern in an electron-ray diffraction image. The composition distribution may be confirmed by using Energy Dispersive X-ray spectroscopy (EDX), Secondary Ionization Mass Spectrometer (SIMS), X-ray photoelectron spectroscopy, and the like. In addition, the information on the density of states of a material may be confirmed by ultraviolet ray photoelectron spectroscopy, X-ray photoelectron spectroscopy, and the like. Furthermore, the density of states in the vicinity of the Fermi level may be evaluated even by measurement of the paramagnetic susceptibility of a prepared sample.

Hereinafter, an example of a sample preparation using the present invention is shown. Here, the preparation example is only an example, and is not limited to the above-described preparation conditions.

### Sample Preparation Example 1

Metal Mn powder having a purity of 99.9% and Si powder having a purity of 99.99% were mixed at a composition ratio of 1:1.75, put into a quartz tube, and subjected to heat treatment at 1150° C. for 24 hr under vacuum atmosphere, and then the sample was ground by using a ball mill and a catalyst of MnSi_{1.75} was prepared. The VEC was calculated as 14 from the prepared composition MnSi_{1.75}.

### Sample Preparation Example 2

Metal Mn powder having a purity of 99.9% and Si powder having a purity of 99.99% were mixed at a composition ratio of 1:2, put into a quartz tube, and subjected to heat treatment at 1150° C. for 24 hr under vacuum atmosphere, and then the sample was ground by using a ball mill. The ground powder was treated with hydrochloric acid and put into an aqueous solution of potassium hydroxide to dissolve the residual Si. Next, filtration was performed and a structural analysis of the sample was performed by performing X-ray diffraction on the sample. As a result, it was confirmed that the sample had a Mn₄Si₇ crystal structure as a fine particle shape. Fine particles of MnSi_{1.75} were prepared by the above-described process and a catalyst of MnSi_{1.75} as a powder shape was prepared. The VEC was calculated as 14 from the prepared composition MnSi_{1.75}.

### Sample Preparation Example 3

Metal Mn powder having a purity of 99.9%, metal Fe powder having a purity of 99.9%, and Si powder having a purity of 99.99% were mixed at a composition ratio of (0.9:0.1:1.75), put into a quartz tube, and subjected to heat treatment at 1150° C. for 24 hr under vacuum atmosphere, and then the sample was ground by using a ball mill and a catalyst of Mn_{0.9}Fe_{0.1}Si_{1.75} was prepared. The VEC was calculated as 14.1 from the composition Mn_{0.9}Fe_{0.1}Si_{1.75}.

### Sample Preparation Example 4

Fe was substituted with Ti, V, Cr, and Co by using a method as in Example 3, and catalysts of Mn_{0.9}Ti_{0.1}Si_{1.75}, Mn_{0.9}V_{0.1}Si_{1.75}, Mn_{0.9}Cr_{0.1}Si_{1.75}, and Mn_{0.9}Co_{0.1}Si_{1.75} were prepared. The VEC was calculated as 13.7, 13.8, 13.9 and 14.2, respectively from these compositions.

### Sample Preparation Example 5

Metal Mn powder having a purity of 99.9%, metal Al powder having a purity of 99.99%, and Si powder having a purity of 99.99% were mixed at a composition ratio of (1:0.1:1.65), put into a quartz tube, and subjected to heat treatment at 1150° C. for 24 hr under vacuum atmosphere, and then the sample was ground by using a ball mill and a catalyst of MnSi_{1.65}Al_{0.1} was prepared. The VEC was calculated as 13.9 from these compositions.

### Sample Preparation Example 6

A thin film having a film thickness of about 300 nm was prepared by using a mixed target which had a composition of 3:1 in Si and Mn to perform sputtering on an Si substrate having a thermal oxidation film, and a heat treatment was performed under a condition of 800° C. in the nitrogen atmosphere for 1 hr. Next, the substrate was dipped in an aqueous solution of potassium hydroxide at 1 mol/l for about 20 sec. The surface roughness thereof was measured by atomic force microscope (AFM), and as a result, surface roughness was increased. This results from the fact that the Si region was dissolved and the surface of MnSi_{1.75} was exposed by dipping the substrate in potassium hydroxide. A structural analysis was performed by X-ray diffraction on the thin film, and as a result, a peak of the Mn₄Si₇ crystal may be observed.

### Sample Preparation Example 7

In order to evaluate the performance as an oxygen reduction catalyst of the catalyst prepared in Preparation Example 3 and Preparation Example 4, powders of MnSi_{1.75}, Mn_{0.9}C_{0.1}Si_{1.75}, and Mn_{0.9}Fe_{0.1}Si_{1.75} were mixed with a conductive carbon at a ratio of 1:1, respectively, and 3 μl of paraffin per 1 g of the mixture was added thereto to manufacture a paste shape.

For comparison, a product (Pt/C) in which platinum is supported on carbon was prepared. These paste samples were applied on a rotating ring disc electrode, and Nafion was used to fix the electrode. The number of electrode rotations was maintained at 1600 rpm. The electrolyte was an aqueous solution of sulfuric acid at 0.5 mol/l, and when the nitrogen gas was supplied and when the oxygen gas was supplied, the reduction current was measured by changing the potential for the hydrogen electrode in a range of 0.0 V to 1.0 V, respectively. Although the oxygen reduction characteristics in MnSi_{1.75} could not be observed under the above-described conditions, the oxygen reduction potentials of Mn_{0.9}Co_{0.1}Si_{1.75}. Mn_{0.9}Fe_{0.1}Si_{1.75}, and Pt/C for comparison were measured at 0.7 V, 0.8 V, and 0.9 V, respectively. The oxygen reduction characteristics could be drastically increased by doping and the material system was comparable to platinum. Accordingly, the oxidation-reduction characteristics according to the present invention could be modified by doping.

In the present embodiment, examples of the thin-film preparation method by sputtering were described, but a vapor deposition method such as molecular beam epitaxy, or a chemical vapor growth using a transition metal complex, and the like may be used. Further, although a flat thin film may be used, it is preferred that when a catalyst is used, nanowires or nanoparticles may be prepared in order to increase the surface area thereof. In the present embodiment, Si and MnSi_{1.75} were subjected to phase separation, and then the difference in rates of dissolution into potassium hydroxide was used and MnSi_{1.75} particles were exposed to the surface thereof. However, fine particles or nanowires may be artificially prepared by using a general method of chemical vapor deposition (CVD). In addition, a molecule including Si or Mn such as SiC₁₄, Mn complex, and the like may be thermally refluxed in an organic solvent and the molecule may be thermally decomposed in an organic solvent to prepare fine particles.

Although embodiments regarding Mn₄Si₇ were described herein, a material system doped with a material system described in the present invention as a parent material, such as TiSi₂, TiGe₂, ZrSn₂, V₁₇Ge₃₁, CrᵤGeₙ, and Mo₉Ge₁₆ which are other Nowotny chimney-ladder phases, or CrSi₂ which has a C40 structure, a full Heusler alloy or a half-Heusler alloy, β-FeSi₂, and the like, may be used.

According to the present invention, the electron occupation number of the d-band may be changed, the electronic structure at the Fermi level may be modified, and oxidation-reduction characteristics may be controlled depending on the purpose by adding an element having a different number of valence electron by doping and controlling the valence electron concentration of a compound.

Hereby, an oxidation and reduction catalyst having a high degree of freedom may be prepared, and the costs may be drastically reduced by combining materials which are inexpensive and less likely to be depleted, compared to a noble metal.

Further, unlike a transition metal complex, the material is composed only of inorganic compounds, and thus it is also possible to prepare complexes while two carrier properties of hole or electron are maintained by controlling the Fermi level thereof, and the electro-conductivity may also be controlled. The effects of controlling the carrier type are apparent in controlling the oxidation-reduction reaction of an electrode catalyst which also requires electro-conductivity.

What is claimed is:

1. A catalyst, comprising:
any one structure of a compound which belongs to the Nowotny chimney-ladder phases, a compound having a C40 structure, a compound having a L2₁ structure, a compound having a C1_{b} structure, and β-FeSi₂ as a main component.

2. The catalyst according to claim 1, wherein in the compound which belongs to the Nowotny chimney-ladder phases and the compound having the C40 structure, the composition of the compound is represented by TₙXₘ, m and n are within a range that satisfies m/n of about 2 to 1.25, T is at least one element selected from Ti, V, Cr, Mn, Fe, Co, Zr, Nb, Mo, Hf, Ta, and W, and X comprises a compound consisting of at least one element selected from Al, Ga, In, Si, Ge, and Sn as a main component.

3. The catalyst according to claim 1, wherein the compounds having the L2₁ structure and the C1_{b} structure comprise at least one element selected from Ti, Zr, Hf, Cr, Mo, W, Mn, Fe, Co, Ni, Cu, Ag, V, Nb, and Ta in a range of 30 to 80 atom % in total.

4. The catalyst according to claim 1, wherein the Fermi level is modified by adding an element which is different from the main component to the compound.

5. The catalyst according to claim 4, wherein the catalyst is a fuel cell electrode catalyst.

6. The catalyst according to claim 4, wherein the catalyst is an exhaust gas catalyst.
